(19) United States
(12) Patent Application Publication
(10) Pub. No.: US 2011/0215752 A1
(43) Pub. Date: Sep. 8, 2011

(54) Fuel Cell Battery Charger

(75) Inventors: Thomas Waters, Traverse City, MI (US); Joseph Engle, Waterford, MI (US); Jason Krajcovic, Ann Arbor, MI (US); Aaron Crumm, Ann Arbor, MI (US)

(73) Assignee: ADAPTIVE MATERIALS, INC., Ann Arbor, MI (US)

(21) Appl. No.: 12/879,648

(22) Filed: Sep. 10, 2010

Related U.S. Application Data
(60) Provisional application No. 61/241,780, filed on Sep. 11, 2009.

(51) Int. Cl. H01M 10/46

(52) U.S. Cl. 320/101

(57) ABSTRACT

A fuel cell battery charger configured to power a rechargeable battery includes a fuel cell and a battery docking station. The battery docking station receives power from the fuel cell, and the battery docking station is configured to charge multiple classes of batteries. Different classes of batteries have at least one of a different shape and a different charging voltage.

### RELATED APPLICATIONS

This invention claims priority benefit of U.S. Provisional Patent Application No. 61/241,780 filed on Sep. 11, 2009, which is hereby incorporated by reference.

### FIELD OF THE INVENTION

This invention relates to fuel cell powered battery chargers.

### BACKGROUND OF THE INVENTION

The statements in this section merely provide background information related to the present disclosure and may not constitute prior art.

Fuel cells can be utilized with portable battery chargers to provide electric power for charging portable batteries. Portable battery chargers utilizing fuel cells and hydrocarbon fuels have a significant specific-energy to weight advantage over batteries. For example, one kilogram of propane utilized within a 300 W solid oxide fuel cell stack can charge fifteen high performance batteries (i.e., BB-2590 lithium ion batteries) weighing 20.9 kg. Therefore, battery chargers with fuel cells are highly desirable for portable applications.

Cost reduction along with improvements in performance and convenience will enable the large-scale adoption of fuel cell powered portable devices. Areas of cost improvements include reducing material costs, improving high volume manufacturing efficiency, decreasing fuel consumption, and decreasing operating costs. Areas for fuel cell performance improvement include fuel cell system weight improvements, fuel cell fuel efficiency improvements, and fuel cell durability improvements.

Currently, commercial and military battery-powered products utilize several different battery types, wherein each battery type can have different size, shape, and voltage requirements. To accommodate the different battery types, battery chargers typically utilize external wires and connectors. The use of multiple connectors and wires requires users to carry multiple wires and install the wires prior to charging, thereby degrading user convenience and enabling opportunities for user error due to improper connection or due to an improper charging setup. Further, charging utilizing multiple types of connectors and wires does not enable battery charging while the user is moving.

Therefore, a robust technology solving problems described above would drive fuel cell demand in the commercial and military marketplace.

### SUMMARY

A fuel cell battery charger configured to power a rechargeable battery includes a fuel cell and a battery docking station. The battery docking station receives power from the fuel cell, and the battery docking station is configured to charge multiple classes of batteries. Different classes of batteries have at least one of a different shape and a different charging voltage.

### BRIEF DESCRIPTION OF THE DRAWINGS

FIG. 1 is a first prospective view of a fuel cell battery charger in accordance with an exemplary embodiment of the present disclosure;

FIG. 2 is a top down view of the fuel cell battery charger of FIG. 1;

FIG. 3 is another prospective view of the fuel cell battery charger of FIG. 1;

FIG. 4 is a prospective view of the fuel cell battery charger of FIG. 1 with a portion of a casing member and battery electronics removed; and

FIG. 5 is a flow chart diagram of the fuel cell battery charger of FIG. 1.

It should be understood that the appended drawings are not necessarily to scale, presenting a somewhat simplified representation of various preferred features illustrative of the basic principles of the invention. The specific design features of the electric power generation device will be determined in part by the particular intended application and use environment. Certain features of the illustrated embodiments have been enlarged or distorted relative to others for visualization and clear understanding. In particular, thin features may be thickened for clarity of illustration.

### DETAILED DESCRIPTION

It will be apparent to those skilled in the art, that is, to those who have knowledge or experience in this area of technology that many uses and design variations are possible for the electric power generation devices disclosed herein. The following detailed discussion of various alternative and preferred features and embodiments will illustrate the general principles of the invention with reference to exemplary electric devices. Other embodiments suitable for other applications will be apparent to those skilled in the art given the benefit of this disclosure.

The present disclosure sets forth an exemplary fuel cell battery charger 10 that can simultaneously charge multiple classes of batteries. In particular, the fuel cell battery charger 10 charges classes of batteries including BB-2590 batteries, LI-145 batteries, and BB-521 batteries. Although batteries of the same class typically comprise similar shapes, general capabilities, and battery chemistry, batteries within each class can vary by electronics architecture, capacity, and operating modes. Further, concepts of the exemplary fuel cell battery charger 10 can be applied to alternate embodiments, wherein additional or alternate battery classifications including alternate battery chemistries (i.e., alternate battery chemistries to the typically lithium ion batteries described above) can be utilized in addition to or instead of those described with respect to the fuel cell battery charger 10.

The fuel cell battery charger 10 can simultaneously charge BB-2590, LI-145, and BB-521 batteries, wherein the total number of battery units the fuel cell battery charger 10 can simultaneously charge equals six battery units, and wherein the BB-2590 battery and LI-145 battery each equal one battery unit and wherein the BB-521 battery equals two battery units. Therefore, when only one battery type is being charged within the fuel cell battery charger 10, the fuel cell battery charger 10 can charge up to six B-2590 batteries, six LI-145 batteries, or three BB-521 batteries.

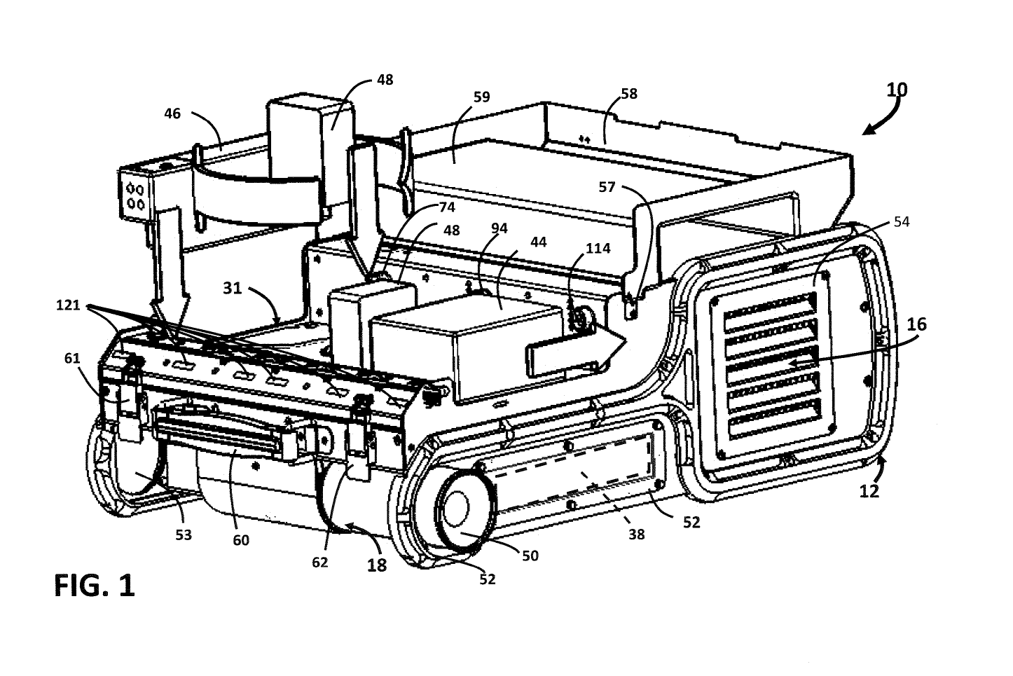

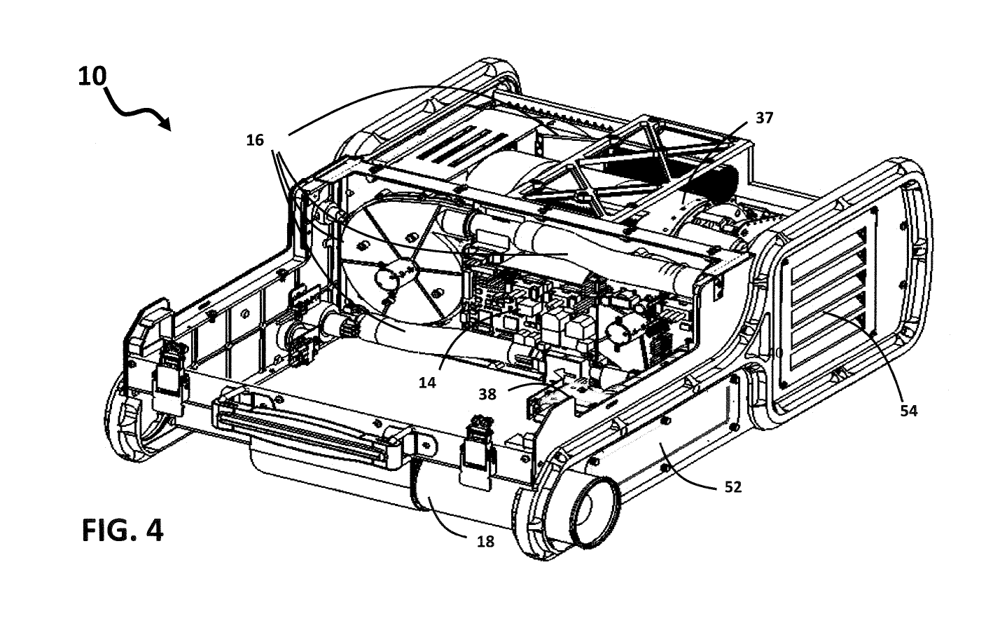

Referring to FIGS. 1 and 4, the exemplary fuel cell battery charger 10 is depicted with a LI-145 battery 46, two BB-2590 batteries 48, and a BB-521 battery 44. The fuel cell battery charger 10 includes a fuel delivery system 18, an air and exhaust management system 16, a fuel cell module 37 an outer housing 12, and a power and control electronics system 14.

The fuel delivery system 18 includes a first fuel attachment portion 52 having a first fuel tank 50 coupled thereto and a second fuel attachment portion 53 configured to receive a second fuel tank (not shown). The fuel delivery system 18 further includes fuel valves, pumps, and fuel conduits for motivating and controlling fuel flow between the fuel tanks and the fuel cell module 37.

The air and exhaust management system 16 includes an air inlet 54 and an exhaust outlet 56. The air and exhaust management system 16 further includes blowers for motivating air and exhaust, filters for removing potential contaminants from the air, and manifolds and conduits for routing air to and exhaust away from portions of the fuel cell module 37.

The exemplary fuel cell module 37 comprises a solid oxide fuel cell comprising several component cells, along with various other components, for example, air and fuel delivery manifolds, current collectors, interconnects, and like components for routing fluid and electrical energy within the fuel cell module 37. The fuel cell module 37 receives air from and exports exhaust fluid to the air and the exhaust management system 16. In particular, the air and exhaust management system 16 provides two air streams to the fuel cell module 37: a first air stream utilized for internal reformation of onboard fuel and a second air stream utilized for electrochemical reactions at the fuel cell cathode. The fuel cell module 37 utilizes the first air stream to reform raw fuel provided by the fuel delivery system 18, converting the raw fuel to reformed fuel. Reformed fuel and oxygen react on opposite fuel cell electrodes to generate electrical energy. The electrical energy is transferred from the fuel cell module 37 to the power and control electronics system 14.

The solid oxide fuel cells generate electrical energy within a thermally insulated, high temperature portion of the fuel cell module by transforming reformed fuel into electrical energy and exhaust gas. High temperature is insulated by a thermally insulative material capable of withstanding the operating temperatures of the fuel cell stack, that is, temperatures of up to 1000 degrees Celsius. The fuel cell module 37 further comprises a heat exchange manifold for transferring heat between fuel cell exhaust gas and the second air stream inputted to the fuel cell stack. In alternative embodiments, other types of fuel cell technology such as proton exchange membrane (PEM), alkaline, direct methanol, and the like can be utilized within the fuel cell battery charger 10 instead of or addition to solid oxide fuel cells.

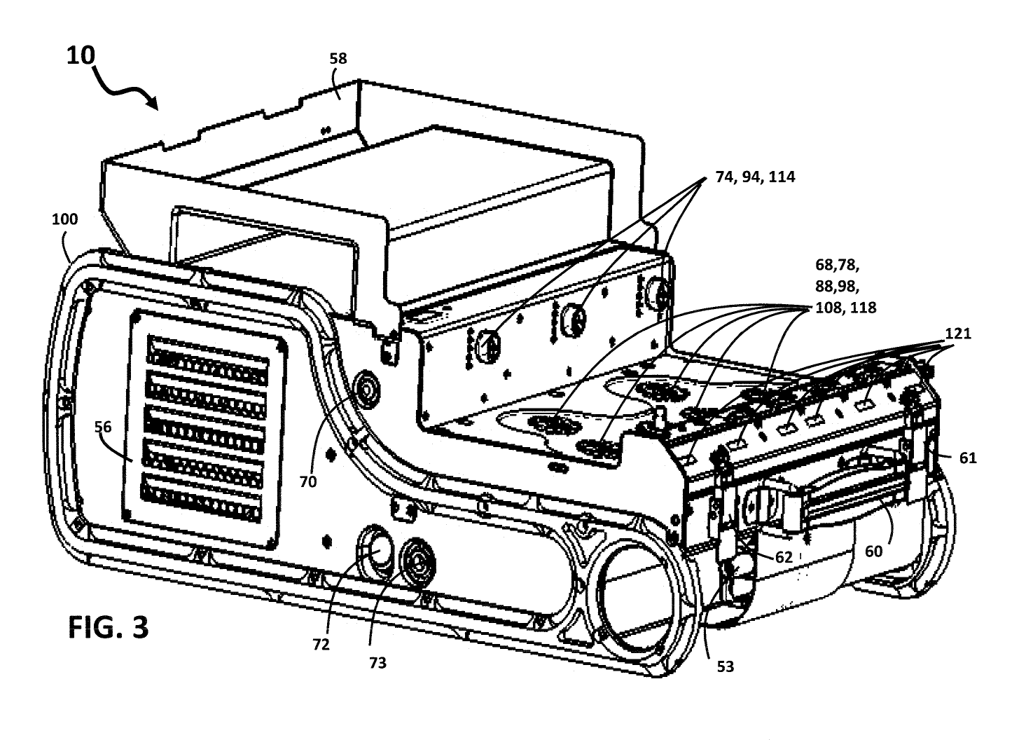

Referring to FIGS. 1-3, the outer housing 12 includes a battery docking station 31, a hybrid battery panel 52, a tray cover 58, a handle 60, latching members 61, 62, a power button 70, a power port 72, and a power routing switch 73.

The battery docking station 31 includes BB-521 battery charging ports 74, 94, 114, LI-145 battery charging ports 66, 76, 86, 96, 106, and 116, BB-2590 battery charging ports 68, 78, 88, 98, 108, and 118, and a charging station display portion 121.

Each BB-521 battery charging port 74, 94, and 114 is configured to electrically couple with the BB-521 battery 44 to enable charging of the BB-521 battery 44 by the fuel cell battery charger 10. Likewise, each LI-145 battery charging port 66, 76, 86, 96, 106, and 116 is configured to electrically couple with the LI-145 battery 46 to enable charging of the LI-145 battery by the fuel cell battery charger 10, and each BB-2590 battery charging port 68, 78, 88, 98, 108, and 118 is configured to electrically couple with the BB-2590 battery 48 to enable charging of the BB-2590 battery by the fuel cell battery charger 10.

The charging station display portion 121 comprises flashing-capable three-color indicators, wherein combinations of color and flashing indicate one of a fully charged battery, a high state of charge battery charging, a low state of charge battery charging, a battery over-temperature event, a battery fault, no battery detected, and a battery charger fault.

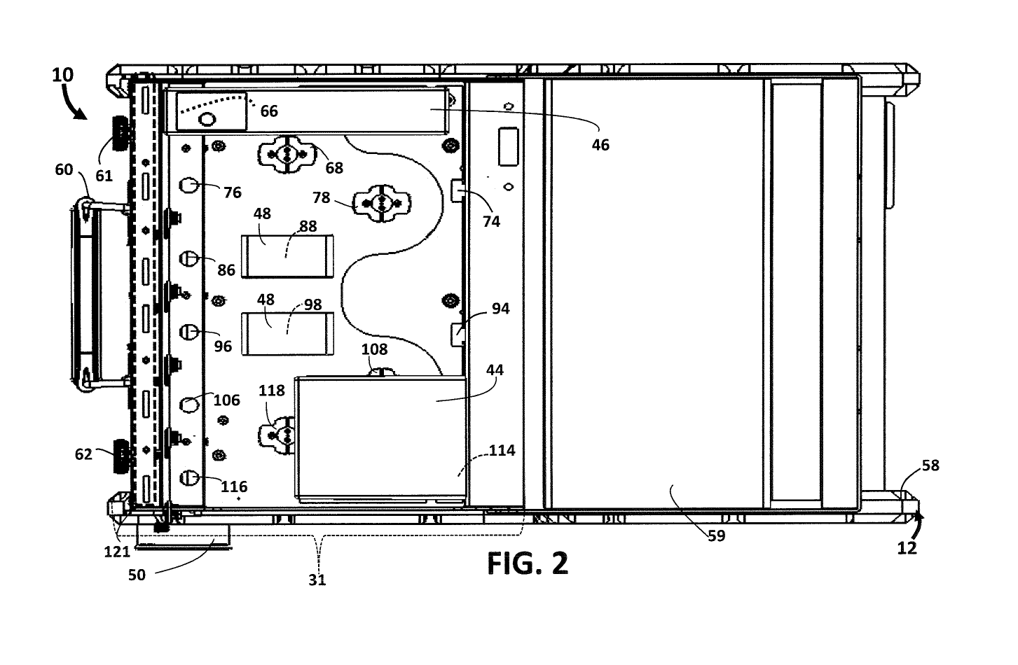

The battery docking station 31 comprises shape features configured for a mating configuration with the BB-521, LI-145, and the BB-2590 batteries. Therefore, outer walls of the batteries abut and are supported by the walls of the battery docking station 31 as depicted in FIGS. 1 and 2.

The arrows of FIG. 1 depict connecting orientation to secure the batteries to the battery charging station 31. The LI-145 battery 46 is connected through motion toward a bottom face of the battery docking station 31, the BB-2590 battery 48 is connected through motion toward the bottom face of the battery docking station subsequently followed by a twisting motion, and the BB-521 battery 44 is connected through motion perpendicular to the bottom face of the battery docking station 31. Therefore, the batteries are connected in a preferred orientation.

The hybrid battery panel 52 is removable such that an internal hybrid battery 38 of the power and control electronics system 14 can be accessed and replaced, and the handle 60 is provided to allow hand carrying of the fuel cell battery charger 10.

The tray cover 58 comprises an electronics guarding portion 59. The tray cover 58 further comprises a hinged joint 57 such that the tray cover 58 can be transitioned between an open position and a closed position. When the tray cover 58 is in the open position, batteries can be coupled to the battery charging ports of the battery charging station 31 to charge the batteries. When the tray cover 58 is in the closed position and when the latching member 61 and 62 are in a latched position, the electronics guarding portion 59 provides a water-tight seal with the battery docking station 31, thereby allowing the fuel cell battery charger 10 to be submerged without permitting water to contact the battery charging ports. Thus, the fuel cell battery charger 10 is waterproof in that the fuel cell battery charger 10 can operate after being submerged in water.

The power button 70 transitions the fuel cell battery charger 10 from an ‘on’ mode wherein batteries coupled to battery charging ports of the battery docking station 31 can actively receive charge from the fuel cell battery charger 10 to an ‘off’ mode wherein batteries coupled to battery charging ports of the battery docking station 31 do not actively receive charge from the fuel cell battery charger 10.

The power port 72 is configured to receive a power cord so that the fuel cell system battery charger 10 can charge an external device. The power routing switch 73 switches the fuel cell battery charger 10 between a battery charging operating mode wherein power is routed to the battery docking station 31 for charging batteries disposed therein and a external device operating mode wherein power is routed to the power port 72 for charging the external device.

Referring to FIGS. 1, 4, and 5, the power and control electronics system 14 includes a controller 20, voltage converters 21, 22, 23, 24, 25, 26, 27, 28, and 29, and a power bus 200. The controller 20 comprises a general-purpose digital computer comprising a microprocessor or central processing unit, storage mediums comprising non-volatile memory, a high speed clock, analog-to-digital conversion circuitry, input/output circuitry and devices, and appropriate signal conditioning and buffering circuitry. The controller 20 can execute a set of algorithms comprising resident program instructions to monitor control signals from sensors disposed throughout the fuel cell battery charger 10 and can execute algorithms in response to the monitored inputs to execute diagnostic routines to monitor power flows and component operations of the fuel cell system 10.

The power bus 200 comprises an electrically conductive network configured to route power within the fuel cell system between the voltage converters 21, 22, 23, 24, 25, 26, 27, 28, and 29 thereby transmitting power between the fuel cell module 37, the hybrid battery 38, the external power port 72, and the external batteries.

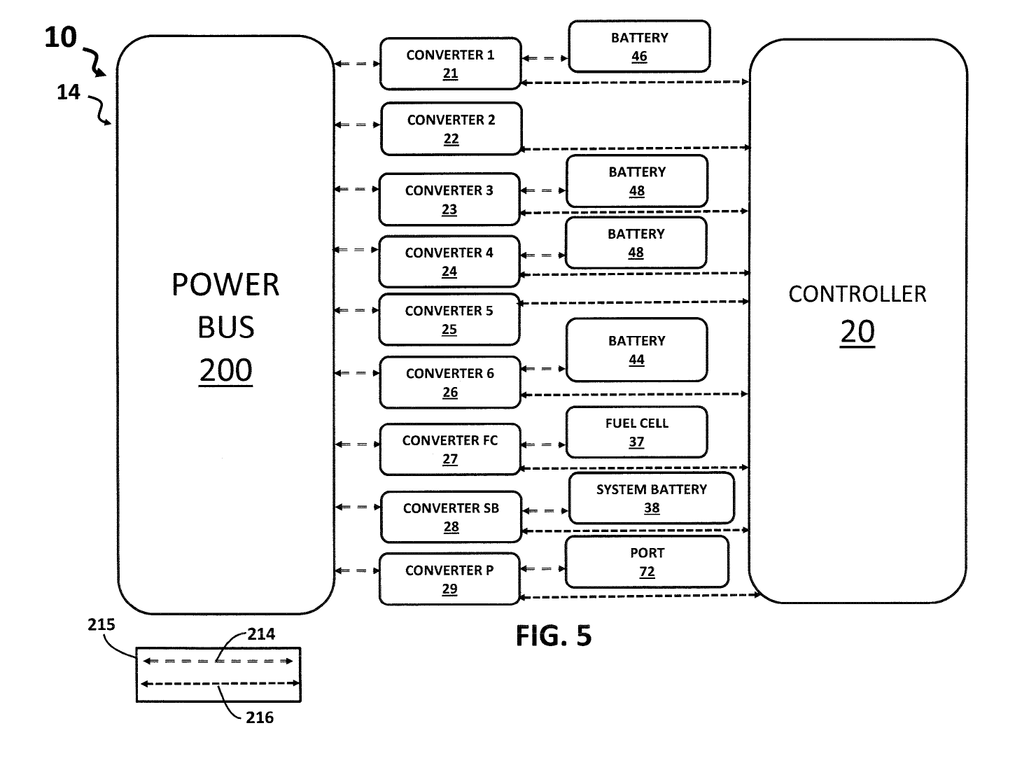

Referring to FIGS. 2 and 5, sets of battery charging ports are grouped such that a first set of battery charging ports including the LI-145 charging port 66 and the BB-2590 charging port 68 is electrically coupled to the voltage converter 21; a second set of battery charging ports including the LI-145 charging port 76, the BB-521 charging port 78, and the BB-2590 charging port 74 is coupled to the voltage converter 22; a third set of battery charging ports including the LI-145 charging port 86 and the BB-2590 charging port 88 is electrically coupled to the voltage converter 23; a fourth set of battery charging ports including the LI-145 charging port 96, the BB-521 charging port 94, and the BB-2590 charging port 98 is coupled to the voltage converter 24; a fifth set of battery charging ports including the LI-145 charging port 106 and the BB-2590 charging port 108 is electrically coupled to the voltage converter 25; a sixth set of battery charging ports including the LI-145 charging port 116, the BB-521 charging port 114, and the BB-2590 charging port 118 is coupled to the voltage converter 26.

When the batteries are positioned within the battery docking station 31 the position of the battery charging ports along with the shape of the batteries prevents charging of more than one battery per voltage converter, thereby eliminating a potential failure mode of the fuel cell system 10.

FIG. 6 depicts signal flow 214 and power flow 216 (see key 215). The fuel cell battery charger 10 identifies the battery and transmits signals to the controller 20 and the fuel cell battery charger 10 commands voltage converters based on the desired charging voltage of the battery class.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A fuel cell battery charger configured to power a rechargeable battery, the fuel cell battery charger comprising:
a fuel cell; and
a battery charging station receiving power from the fuel cell, the battery charging port being configured to charge multiple battery classes, wherein each battery class comprises at least one of a different shape and a different charging voltage configuration.

2. The fuel cell battery charger of claim 1, wherein the battery charging station is configured to simultaneously charge a first battery of a first battery class and a second battery of a second battery class.

3. The fuel cell battery charger of claim 1, further comprising an outer housing, the battery charging station is configured to receive the rechargeable battery such that a wall of the rechargeable battery abuts a wall of the outer housing.

4. The fuel cell battery charger of claim 3, wherein the multiple battery classes comprise at least two of a BB-2590 rechargeable battery, a Li-145 rechargeable battery and a BB-521 rechargeable battery, such that the electrically coupled rechargeable battery abuts the wall of the outer housing.

5. The fuel cell battery charger of claim 3, wherein the multiple battery classes comprise a BB-2590 rechargeable battery, a Li-145 rechargeable battery and a BB-521 rechargeable battery.

6. The fuel cell battery charger of claim 5, further comprising a first battery charging port electrically connected to a first rechargeable battery, a second battery charging port electrically connected to a second rechargeable battery, and a third battery charging port electrically connected to a third rechargeable battery, the battery charging ports simultaneously routing power from the power bus to the rechargeable batteries.

7. The fuel cell battery charger of claim 6, wherein the first charging port is providing electric power to a BB-2590 battery, the second charging port is providing electric power to a Li-145 battery and the third charging port is providing electric power to a BB-521 battery.

8. The fuel cell battery charger of claim 6, wherein the fuel cell battery charger is configured to simultaneously charge three batteries.

9. The solid oxide fuel cell of claim 8, wherein the fuel cell battery charger is configured to simultaneously charge six batteries.

10. The fuel cell battery charger of claim 1, further comprising a power bus and a hybrid battery, the hybrid battery being configured to receive power from the power bus and transmit power to the power bus.

11. A fuel cell battery charger comprising:
a power bus;
a fuel cell voltage converter, a hybrid battery voltage converter, and a plurality of battery charging port voltage converters;
a hybrid battery electrically coupled to the power bus through the hybrid battery voltage converter;
a fuel cell electrically coupled to the power bus through the fuel cell voltage converter; and
a plurality of battery charging port comprising a plurality of charging ports, the plurality of charging ports being electrically coupled to the power bus through the plurality of battery charging port voltage converters, the plurality of battery charging ports being configured to provide power to multiple classes of rechargeable batteries the plurality of charging ports, wherein each class of rechargeable battery comprises a different shape and a different charging voltage configuration.

12. The fuel cell battery charger of claim 11, wherein the battery charging port permits battery charging only when the rechargeable battery is positioned in the battery charging port in a preferred orientation.

13. The fuel cell battery charger of claim 11, wherein the fuel cell battery charger is configured to simultaneously charge six external batteries.

14. The fuel cell battery charger of claim 11, wherein the battery charging port is configured to charge any one of a BB-2590 battery, a Li-145 battery and a BB-521 battery.

15. The fuel cell battery charger of claim 12, wherein the battery charging port is configured to simultaneously charger any two batteries of the group consisting of the BB-2590 battery, the Li-145 battery and the BB-521 battery.

16. The fuel cell battery charger of claim 11 further comprising a fuel tank module, the fuel tank receiving module comprising a replaceable fuel tank providing fuel to the fuel cell.

17. The fuel cell battery charger of claim 16, wherein the fuel tank includes propane fuel.

18. The fuel cell battery charger of claim 11 further comprising a power port configured to receive a power cable.

19. The fuel cell battery charger of claim 11, further comprising a tray cover, wherein the fuel cell power battery charger is water submersible when the tray is in a closed position.
